(19) United States
(12) Patent Application Publication
(10) Pub. No.: US 2004/0253360 A1
(43) Pub. Date: Dec. 16, 2004

(54) Hard frozen food containing alcohol

(76) Inventor: John B. Squicciarini, Aliso Viejo, CA (US)

Correspondence Address: ROBERT D. FISH, RUTAN & TUCKER LLP, 611 ANTON BLVD 14TH FLOOR, COSTA MESA, CA, 92626-1931, US

(21) Appl. No.: 10/459,257

(22) Filed: Jun. 10, 2003

(51) Int. Cl. C12G 1/00

(52) U.S. Cl. 426/592

(57) ABSTRACT

The present invention is directed to a frozen beverage having a combination of a drug and a gelling agent. The combination is generally maintained at a temperature of 120 degrees F. for at least one minute before completing the remaining steps. In a preferred embodiment, the frozen beverage is hard frozen in the form of a pop and contains ethyl alcohol as the drug and pectin as the gelling agent.

### FIELD OF THE INVENTION

The field of the invention is food containing alcohol.

### BACKGROUND OF THE INVENTION

Alcoholic frozen drinks are soft ice or slushy beverages. Such drinks are typically prepared by blending alcohol, ice, and a drink mix in a blender. The result is a thick cold drink with small pieces of ice. It became known to sell such drinks in a ready made form that did not need to have the ice or alcohol blended in. Such drinks only needed to placed in the freezer for a certain period of time before being consumed. U.S. Pat. No. 4,790,999 to Ashmont et al. (December 1988) teaches a beverage which forms a “soft ice” when frozen and which can be consumed “as is” or can be spooned into a glass. Another patent teaching a soft frozen drink is U.S. Pat. No. 5,866,191 to Mancuso (February 1999). The '191 patent describes a beverage composition that remains soft at freezer temperatures as low as 0° F. While the '999 and 191 patents may provide ready made frozen alcoholic drinks, these drinks melt quickly, especially in warm temperatures, and refreezing the drinks is not a viable alternative since the alcohol and water will separate upon melting and remain separate.

A frozen desert containing aerated gelatin is discussed in U.S. Pat. No. 4,297,379 to Topalian et al. The frozen desert is said to be portable and supportable on a stick, however such gelatin is soft and easily falls from the stick. It has now become known to include alcohol into a frozen gelatin type food. For example, Electric Jello™ is a product that comprises vodka (or another alcohol) mixed with a prepared gelatin before being frozen. These alcoholic gelatin products are made by adding alcohol after the gelatin has been heated, but before refrigerating. Still, alcoholic gelatin deserts do not freeze to a sufficient hardness to be held securely on a stick.

U.S. Pat. No. 4,350,712 teaches a frozen beer or wine stick that freezes to a “solid bar”. Because beer and wine generally comprise less alcohol content than other harder liquors, they may freeze to a relatively harder state, however, bars produced essentially from beer or wine are still relatively soft and do not have the same flaky consistency as pops without alcohol. The '712 patent does not disclose a hard frozen bar that is independently supported on a stick. Instead, the '712 patent teaches a “frozen” bar in a retractable cup. The retractable cup surrounds the bar and holds it to a stick. When desiring to lick or bite the bar, the cup is slid down against a spring.

Thus, there is a need for a hard frozen food containing a relatively high alcohol content.

### SUMMARY OF THE INVENTION

The present invention is directed to a frozen beverage having a combination of a drug and a gelling agent. The combination is maintained at a temperature of 120 degrees F. for at least one minute. In a preferred embodiment, the frozen beverage is hard frozen in the form of a pop and contains ethyl alcohol as the drug and pectin as the gelling agent.

In another aspect, the present invention includes methods of producing a frozen food by first cooking a gelling agent and a drug together, then mixing a flavor into the cooked combination. The combination can be dispensed into a freezer pop container and shipped and shelved in an unfrozen state.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic showing steps in the production of a prior art food.

FIG. 2 is a schematic for production of a frozen pop.

### DETAILED DESCRIPTION

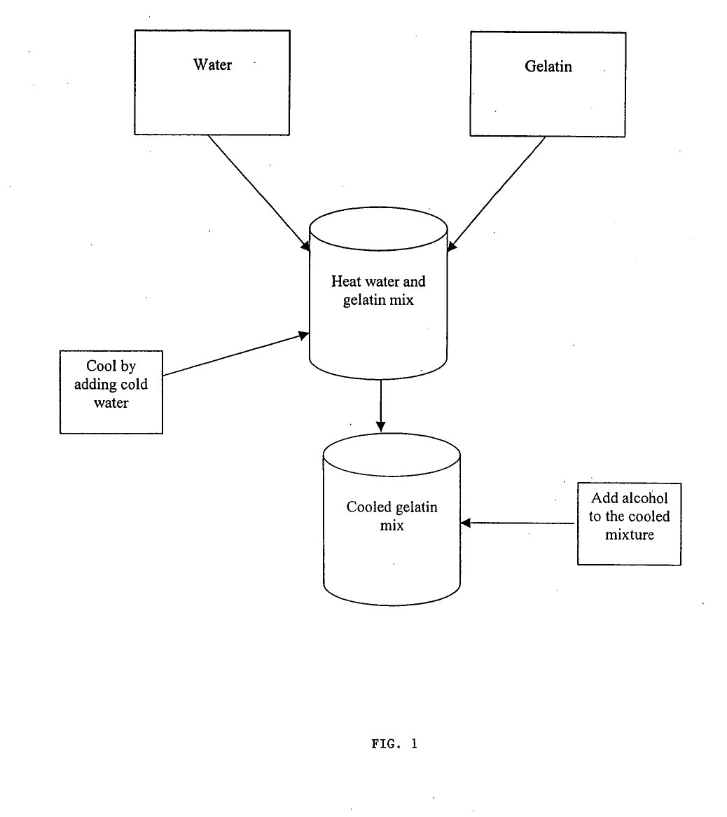

Referring first to FIG. 1, a prior art food is prepared by first heating 130 a water 110 and gelatin 120 mixture. This is typically accomplished by boiling the water then adding the gelatin mixture, which may be flavored. It is important to recognize that addition of alcohol to the mixture only occurs after the mixture has been cooled by adding cold water 140. The mixture may be cooled by other means, however so long as the alcohol 150 is added when the mixture is in a relatively cool state 160.

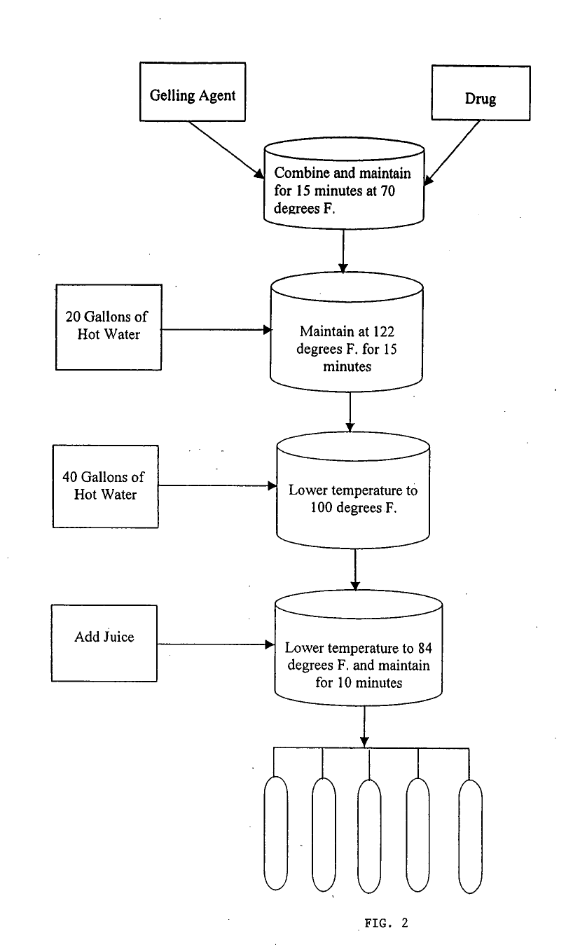

The inventive subject matter exemplified by FIG. 2 depicts ingredients and steps in the production of a frozen pop. In a first step, a gelling agent 220 is combined with a drug 210. A gelling agent is a compound that causes firmness or gelling. Gelling agents include pectin (a polysaccharide found in nearly all plant tissue), cellulose, carrageenan and gelatin. A drug is any molecule or composition of molecules that alters structure, metabolism, cell cycle and/or function of a diseased or otherwise negatively impacted cell or organ. For example, contemplated drugs include anti-neoplastic drugs (e.g 5-FU, taxol, etc.), anti-metabolites (e.g., trimethoprim, sulfonamides, etc.), antibiotics (e.g., beta-lactam antibiotics, tetracycline antibiotics, etc.), and anti-viral agents (e.g., ribavirin, T-20, etc.), immunomodulatory agents (e.g., steroids, cytokines, etc.), pro-, and anti-apoptotic agents, receptor blockers (e.g., beta blockers), enzyme inhibitors (e.g., statins), as well as ethanol (i.e. ethyl alcohol).

As depicted, the gelling agent and drug are combined and then maintained for 15 minutes at around 70 degrees F. in step 230. Following this step, the drug/agent combination 250 is brought to a temperature of about 122 degrees F. by adding 20 gallons of hot water 240. The drug/agent combination is maintained at about 122 degrees F. for about 15 minutes in step 245. With regard to the temperature and the time in which the temperature is maintained, there is room for variance. For example, it is contemplated that the temperature can range from 105 to 150 degrees F. and the time can range from 10 to 30 minutes. The time and temperature may be related in that a relatively high temperature may require relatively less time, and a relatively low temperature may require relatively more time—all within the ranges stated above.

“Maintaining” as defined herein means sustaining the heat (at about 122 degrees F.) with the intent to sustain the heat. “Maintaining” is a purposeful act and does not include non-intentional maintenance within the range of required temperature. For example, if the substance were in a truck within which the temperature reached around 120 degrees F. In an embodiment having an ethyl alcohol, the gelling agent bonds to the alcohol (OH) molecule during this stage 245. In such embodiments, it is preferred that a neutral (i.e. substantially clear and tasteless) alcohol be used such as that produced from grapes or from oranges.

Introduction of additional hot water 250 is used to lower the temperature of the combination to around 100 degrees F. in step 260. Following this step, juice 270 is optionally added to provide flavor and to aid in consistency. A preferable juice contains real fruit (e.g. Dole™ Pineapple Juice ) and may even contain pieces of real fruit. In any event, the addition of the juice brings the temperature of the mixture down to about 84 degrees F. which is preferably maintained for about 10 minutes as shown in step 280.

For purposes of producing an alcoholic frozen beverage, it is advantageous to add flavoring (e.g. S&S Flavoring), to a neutral alcohol mixture in order to better replicate drinks produced with flavored alcohol and drink mixes. A neutral mixture can be frozen into units wherein each unit is sufficient for one drink. There are many benefits associated with using pre-frozen units including obtaining a more consistent flavor and texture, increasing the speed within which drinks can be made, and aiding in the auditing of the number of alcoholic beverages sold. For example, consumption of one frozen unit equals one drink sold.

The mixture is poured into molds 290 then frozen. The pops can be frozen to a hard state (e.g. a fruit pop or ice cube) or to some softer state such as a slush. Additionally, the mixture can be frozen in various containers or molds of various shapes and sizes. For example, it may be advantageous to freeze a mixture in a paper cup and eat it with a spoon rather than from a pop. Another embodiment may include freezing the mixture in the form of an ice cube and using the ice cube in a drink. Such frozen beverages can also be decorative having various colors and even brands or trademarks frozen into them. It is further contemplated that objects (edible and non-edible) can be frozen into a frozen beverage. Consider a frozen ice cube with an advertisement such as an ice cube having a Jack Daniels™ logo. It is preferred that an alcoholic mixture be placed into liquid brine and cooled to a temperature lower than −20 degrees F.

The result of a mixture according to the steps outlined above is a frozen beverage generally having crystal flakes throughout and a relatively slow melting time compared to other frozen beverages.

The alcohol or other drug content of the product can vary widely from 1% or less, to 5, 10, or even 20% or more.

An item of manufacture may have been produced by performing the above steps with the exception of freezing the mixture. Thus, such items can be shipped and sold in an unfrozen state. By allowing such items to be shipped and sold unfrozen, many of the special handling and storage requirements are obviated. A consumer may either freeze the mixture at home or a vendor of the frozen beverage may freeze it before the consumer buys it. Moreover, where a pharmaceutical drug is concerned, the frozen beverage may be dispensed only by a pharmacist or doctor and it would be more convenient if such items did not require that they be frozen when dispensed. In any event, a frozen beverage is intended to be frozen before being consumed.

In another example, 25 gallons of 48 proof (24%) rum is mixed with 3 quarts of gelling agent (1 quart each of three different agents). The mixture of the rum and gelling agents sits for 5 to 15 minutes at approximately 70 degrees F. Next, 20 gallons of hot water (at approximately 135 degrees F.) is added to the mixture bringing the temperature to about 122 degrees F. for 5 to 15 minutes. In the next step, the temperature of the mixture is brought down to about 100 degrees F. by adding approximately 40 gallons of water. 75 gallons of pineapple juice is added to the mixture which then sits for approximately 10 minutes at around 96 degrees F. At this point, rather than pass the mixture through a cooler system, the mixture was poured into molds at a temperature of about 88 degrees F. The molds were placed into a freezer and frozen to a temperature of −20 degrees F. Additionally, it may become necessary to add a defoamer to reduce the amount of foam caused by freezer impeller blades.

A further example begins with mixing 25 gallons of 80 proof Jose Cuervo™ tequila with three gelling agents. The mixture is maintained at around 70 degrees F. for 15 minutes or more. Next, 20 gallons of hot water (135 degrees F.) is added to the mixture and the mixture is maintained at around 122 degrees F. for at least 15 minutes. 40 gallons of cooler water is added bringing the mixture temperature down to 100 degrees F. before adding 75 gallons of strawberry margarita mix. The mixture is left to sit for around 10 minutes at 84 degrees F. Following this step, the 80 degree F. mixture is poured into molds and frozen to −20 degrees F.

During the process, the gelling agent is bonded to the drug and then the other ingredients (water, sugar, acid, flavoring, juice etc.) bond to the gelling agent. Even in a hard frozen alcoholic beverage, the alcohol does not actually freeze, but is encapsulated in the lattice formed by the other ingredients. Similar to candy with a liquid center, the hard shell protects the drug from escaping.

Thus, specific embodiments and applications of a frozen beverage have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A frozen beverage, comprising
a combination of a drug and a gelling agent, the combination maintained at a temperature of at least 120 degrees F. for at least one minute.

2. The frozen beverage of claim 1, wherein the drug is an antibiotic.

3. The frozen beverage of claim 1, wherein the drug is an anti-neoplastic.

4. The frozen beverage of claim 1, wherein the drug is an anti-metabolite.

5. The frozen beverage of claim 1, wherein the drug is an anti-viral agent.

6. The frozen beverage of claim 1, wherein the drug comprises ethanol.

7. The frozen beverage of claim 6, wherein the drug is substantially clear and tasteless.

8. The frozen beverage of claim 6, wherein the drug is a whiskey.

9. The frozen beverage of claim 6, wherein the drug is a vodka.

10. The frozen beverage of claim 6, wherein the drug is a wine.

11. The frozen beverage of claim 6, wherein the drug is a gin.

12. The frozen beverage of claim 1, wherein the gelling agent comprises pectin.

13. The frozen beverage of claim 1, wherein the gelling agent comprises cellulose.

14. The frozen beverage of claim 1, wherein the gelling agent comprises gelatin.

15. The frozen beverage of claim 1, packaged in a freezer pop container.

16. The frozen beverage of claim 1, hard frozen at the time of consumption.

17. The frozen beverage of claim 1, slush frozen at the time of consumption.

18. The frozen beverage of claim 1, wherein the drug comprises at least 5% of the frozen beverage by weight.

19. A method of producing a frozen food, comprising the ordered steps of:
cooking a gelling agent and a drug; and
mixing a flavor into the cooked combination.

20. The method of claim 19, further comprising a subsequent step of dispensing the cooked combination into a freezer pop container.
